(19) United States
(12) Patent Application Publication
(10) Pub. No.: US 2025/0259229 A1
(43) Pub. Date: Aug. 14, 2025

(54) PRODUCT IDENTIFICATION AND LOCATION NOTIFICATION BASED ON USER PRODUCT SPECIFICATION

(71) Applicant: Microchip Technology Incorporated, Chandler, AZ (US)

(72) Inventors: Gheorghe Turcan, Bucharest (RO); Valentin Stoia, Bucharest (RO)

(73) Assignee: Microchip Technology Incorporated, Chandler, AZ (US)

(21) Appl. No.: 18/644,380

(22) Filed: Apr. 24, 2024

Related U.S. Application Data
(60) Provisional application No. 63/551,208, filed on Feb. 8, 2024.

(51) Int. Cl. G06Q 30/0601; G06K 7/10

(52) U.S. Cl. CPC G06Q 30/0639; G06K 7/10445; G06Q 30/0627

(57) ABSTRACT

Methods and systems are provided for associating respective ones of a plurality of beacons with respective ones of a plurality of products; receiving a product specification from a user; identifying a product of the plurality of products corresponding to the product specification; and notifying the user of the location of a respective beacon of the plurality of beacons associated with the identified product.

### CROSS-REFERENCE TO RELATED APPLICATIONS

The present application claims priority to U.S. Provisional Patent Application No. 63/551,208 filed Feb. 8, 2024, the contents of which are hereby incorporated in their entirety.

### TECHNICAL FIELD

The present disclosure relates to systems and methods to assist shoppers, in particular, beacons are associated with products to assist customers to locate and identify products.

### BACKGROUND

Big stores have so many products, that it takes a long time to find products with a desired specification, brand, measure or quality. Online stores have the disadvantage of not feeling or trying the products, so people prefer physical stores to eliminate the hardship of many returns for few kept items. Different stores in the same commercial center may have the same desired products but at different prices/offers, it takes half a day to go through all of them. Online stores allow users to search for products based on filter criteria. If the filtered products are not available, it is tiresome to find similar options.

Stores reshuffle products to induce increase sales, but customers end up frustrated because they cannot locate the products they desire to purchase. Customers do not put the products back at the designated place so that product may be misplaced throughout a store. The product is touched just to check the specifications/size, without limitation, which may result in damaged or soiled goods. Employees need to learn a huge variety of products and specifications. While stores organize shop products per categories—still too many options exist, and those options do not necessarily match the buyer's needs.

There is a need for systems and methods to assist shoppers to locate products meeting the shopper's product specifications.

### SUMMARY

An aspect provides a method comprising: associating respective ones of a plurality of beacons with respective ones of a plurality of products; receiving a product specification from a user; identifying a product of the plurality of products corresponding to the product specification; notifying the user of the location of a respective beacon of the plurality of beacons associated with the identified product.

An aspect provides a system comprising: a server; a base station to communicate with the server; a plurality of beacons to communicate with the base station, wherein respective ones of the beacons are to be associated with respective ones of products, wherein respective ones of the beacons comprise a power supply, a circuit to control a beacon, a data memory, and a wireless communicator; an application executable on a processor of a mobile computing device to receive a product specification from a user and to communicate the product specification to the server; and an application executable on the server to receive the communicated product specification, identify a respective one of the plurality of beacons associated with the respective product corresponding to the product specification, and generate an instruction to notify the user of the location of the identified beacon.

According to an aspect, there is provided an application executable on a processor of a mobile computing device, wherein the application is to: receive an input product specification from a user; communicate the product specification to a server; receive beacon location information from a server for a beacon associated with a product corresponding to the product specification; inform a user regarding a location of a beacon based on the beacon location information.

### BRIEF DESCRIPTION OF THE DRAWINGS

The figures illustrate examples of associating beacons with products, receiving product specifications from a user, identifying a product corresponding to the product specifications, and notifying the user of the location of a beacon associated with the identified product.

FIGS. 1A, 1B, and 1C show three views of a mobile computing device illustrating features of a shopping assistant application on a mobile computing device.

FIGS. 2A and 2B show a base station and product beacon system. Using the example of a clothing store, individual beacons are attached to individual hangars, wherein clothing being offered for sale may be hung on the hangers for presentation to user and customers.

FIGS. 3A, 3B, and 3C illustrate a product notification system, where an aisle within a store provides access to clothing products, wherein each product is hung on a respective hanger.

FIG. 4 illustrates a block diagram of an in-store product identification system, the system comprising beacons, mobile computing devices, and a server/station system.

FIG. 5 illustrates a block diagram of an in-store product identification system, the system comprising a plurality of beacons, a base station, a mobile computing device, and a server.

FIG. 6 shows a flow chart of a method for users to identify and locate products. A plurality of products are associated 602 with a plurality of beacons. Product specifications are received 604 from a user.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect, there is provided a shopping system that may reduce time spent during live shopping and increase the likelihood of finding products desired. Users or customers may use an application on a mobile computing device to engage the system. The system provides easy to see data and allows the user to filter a lot of information in a very short time. The system may keep a log of purchased products and individual user product preferences. The system may allow for beacons to be (re)programmed when associated with products, and beacons may communicate directly with products via an article information/notification emitter, an RFID tag, or a QR image reader. The beacons may be small in size so they may be placed on hangers, attached to a shelf, affixed to a price tag, without limitation.

The system thus may allow a consumer to gain time when shopping, eliminate crowding, and help ensure that customers are satisfied.

The system may keep track of overall customer preferences and may help reduce the number of low-demand products from being sold cheaply or discarded as trash.

The system and method may be provided for a first customer interaction that is supported by a phone application which communicates with the store base station that holds the real time stock details and in-store product arrangement. A second customer interaction may provide a map-like depiction of selected/filtered products, and a final customer guide interaction may be near the products, where a visual notification device may be used to help identify the desired product.

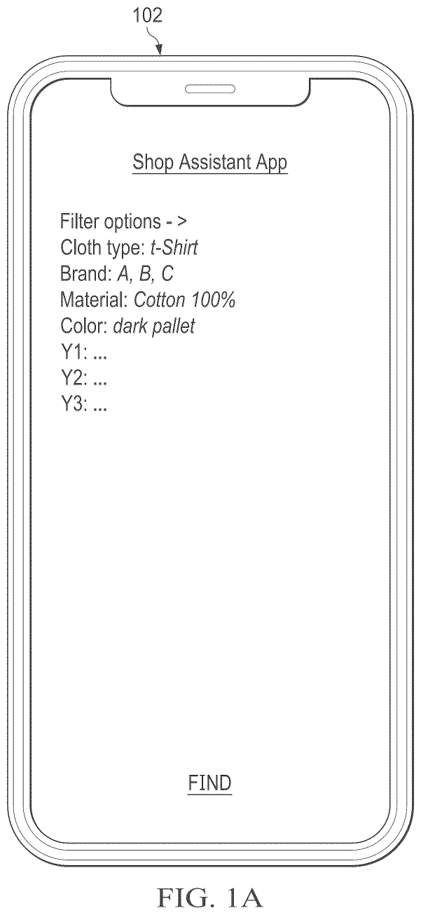

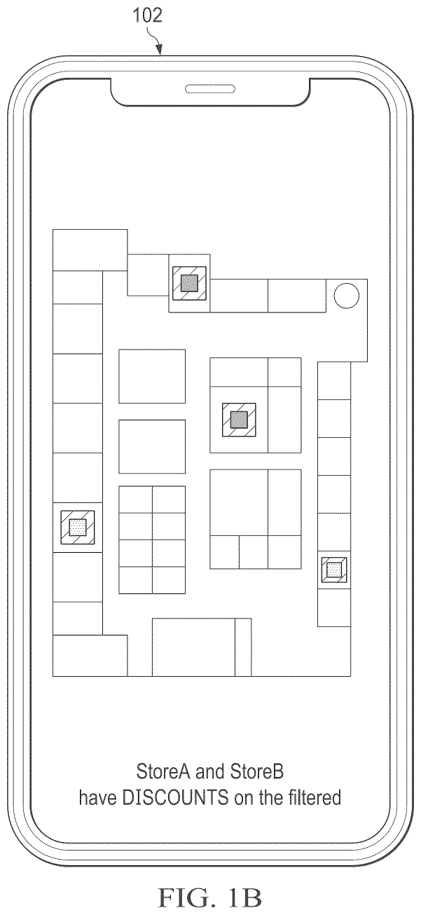

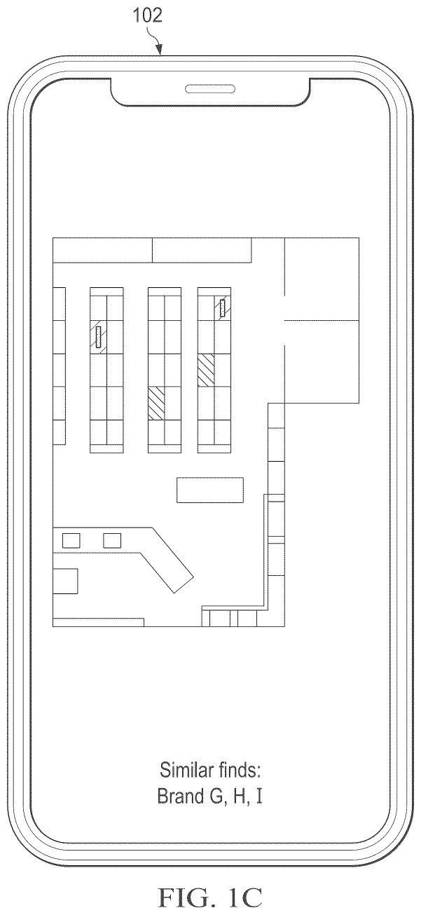

FIGS. 1A, 1B, and 1C show three views of a mobile computing device 102 illustrating features of a shopping assistant application. FIG. 1A shows a page display by which a user may enter search criteria including information and features of a product for which the user is searching. FIG. 1B shows a page display of a mall layout view, wherein stores within the mall are identified on a map as having products satisfying the user's search criteria. FIG. 1C is a page display of a store layout view, wherein aisles within the store are shown and products satisfying the user's search criteria are identified relative to the aisles within the store.

The shopping assistant application for mobile computing devices may help with user product preferences and user shopping list compilation. It may generate maps for display on a mobile computing device, wherein the maps may depict the shops or stores that may hold the desired products in current inventory. The shopping assistant application may notify users whether there are discounts/sales being offered for particular products by particular stores. The shopping assistant application for mobile computing devices may specify the exact location of the products for which a user is searching. If the specified or filtered products are not satisfactory to the user, the shopping assistant application may help the user to find similar selections from different brands by providing product specification and location information relative to nearby stores. The shopping assistant application may hold a user purchase history, and downloads tags and specifications of the products in the user purchase history. The mobile computing device 102 may have a processor and a shopping assistant application executable by the processor.

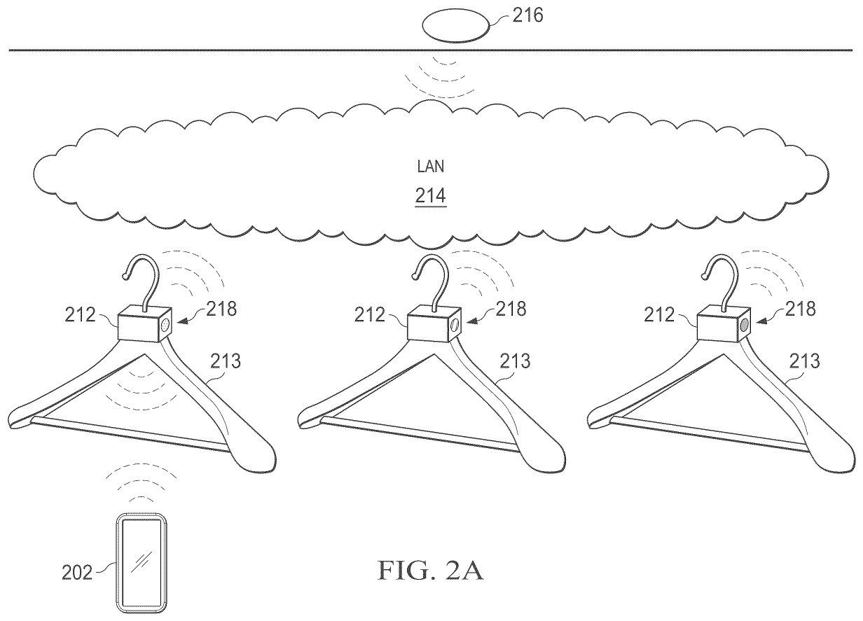

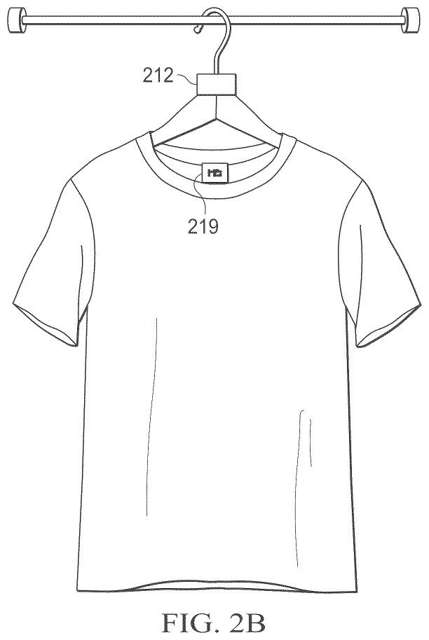

FIGS. 2A and 2B show a base station and product beacon system. Using the example of a clothing store, individual beacons 212 are attached to individual hangars 213, wherein clothing being offered for sale may be hung on the hangers 213 for presentation to user and customers. One or more base stations 216 are located within the store, for example in the ceiling of the store. The base station 216 may communicate via wireless signal transmission, such as radio frequency, over a local area network (LAN) 214 with the beacons 212. Articles of clothing may further have a tag 219, such as an RFID tag or a tag displaying a QR code, to be read by a scanner on each beacon 212 or by a camera of a mobile computing device 202 for identification. A beacon 212 may be associated with a product when the beacon 212 senses a product proximate a beacon 212 via a scanner or camera on the beacon. A beacon 212 may read a readable code, such as for example a QR code, via a scanner or camera on the beacon 212. A beacon 212 may read an RFID tag via a scanner or camera on the beacon 212. A beacon 212 may have a sensor of a product proximate the beacon 212. A server (not shown) may be in communication with the plurality of beacons 212. The mobile computing device 202 may have a processor and a shopping assistant application executable by the processor. The shopping assistant application may receive product specifications from the user, and may communicate the product specifications to the server (not shown).

The beacons 212 may be attached to hangers 213 so that the beacons 212 themselves or a tag 219 may be scanned by a mobile computing device 202 or other device to identify the product item and confirm its presence. The beacons 212 may communicate with the base station 216 via a local area network (LAN) 214. The beacons 212 may also communicate directly or indirectly with mobile computing devices 202. The beacons 212 may notify customers in close proximity to a product and identify for the user that the product satisfies the user's search criteria, by illuminating a color-coded indicator 218, such as a light, for the user to visually see or by transmitting a signal to the user's mobile computing device 202 to provide an alert to the user. The user may be notified of the location of the respective beacon associated with the identified product by activating an alert on a mobile computing device. The beacon 212 may be low power and support recharging. The beacon 212 may activate, or wake up, when needed and may support multiple user notification methods.

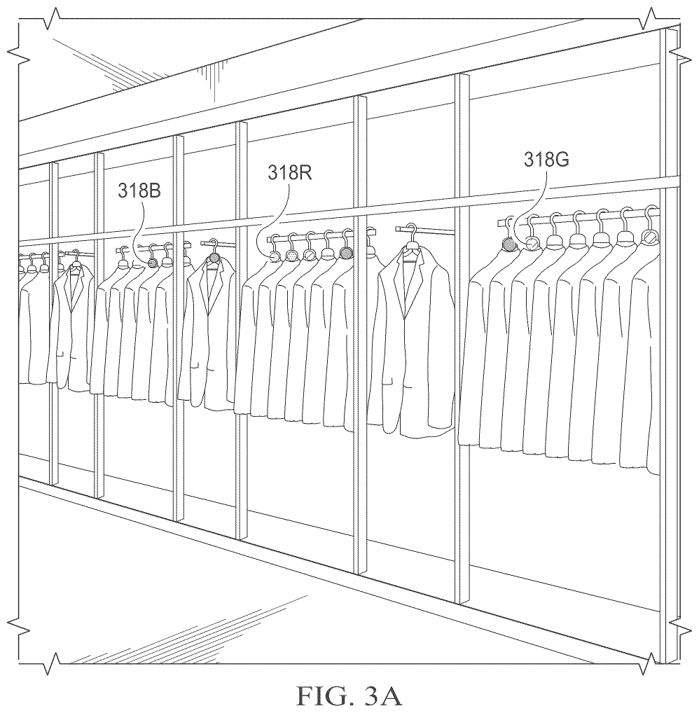

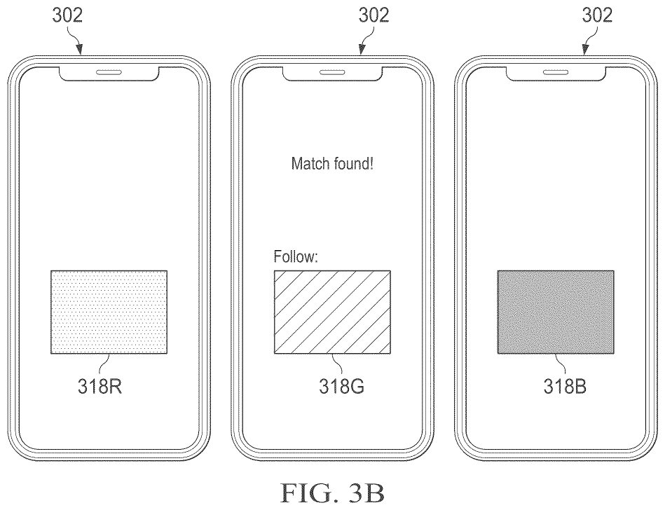

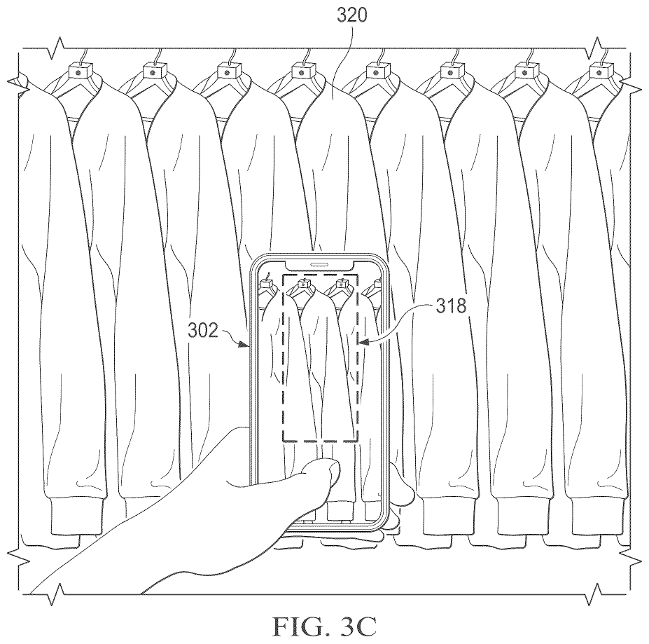

FIGS. 3A, 3B, and 3C illustrate a product notification system. FIG. 3A shows an aisle within a store providing access to clothing products wherein each product is hung on a respective hanger. The respective hangers have beacons attached thereto so that the beacons are visible to users even when a clothing product is hung on the hanger. The beacons may display color-coded indicators 318, such as lights, to users in the aisle of the store. FIG. 3B shows three mobile computing devices 302 displaying a color-coded indicator 318, wherein the color of the indicator 318 displayed on the mobile computing device 302 (see FIG. 3B) may be the same color as an indicator 318 displayed by a beacon 312 in an aisle of the store (see FIG. 3A), e.g., 318R for a red indicator, 318G for a green indicator and 318B for a blue indicator. FIG. 3C shows a mobile computing device 302 and beacons 312 attached to hangers in the aisle of a clothing store. The color-coded indicator 318, such as lights, of the beacons 312 may match the color-coded indicators 318 of the mobile computing device 302 so users may identify and locate products that meet their search criteria. A respective beacon 312 of a plurality of beacons may be identified that is associated with a product 320 corresponding to the product specification provided by the user. As shown in FIG. 3C, a camera of a mobile computing device 302 may be used to view the clothing in the store aisle via a display of the mobile computing device 302. The beacon 312 of a hanger with a clothing product satisfying the user's search criteria and being viewed on the display of the mobile computing device 302 may send a signal to the mobile computing device 302 to cause the mobile computing device 302 to display an indicator 318, such as a red box on the display positioned relative to the clothing product, so the user can identify the clothing product. The mobile computing device indicates the product viewable on the display, so the user can identify the product satisfying the user's product specification.

The beacon 312 may interact directly with customers via visible or non-visible light spectrum, or it may provide audible communications. The beacon 312 may interact indirectly with customers by sending signals to the user's mobile computing device. The beacons 312 may service multiple customers or users in a store aisle by using different indicators, for example, different colors. As shown in FIGS. 3A and 3B, a first user may be provided a red indicator 318R on their respective mobile computing device 302 and red lights may illuminate from indicators 318R of the beacons indicating clothing products satisfying search criteria of the first user. A second user may be provided a green indicator 318G on their respective mobile computing device 302 and green lights may illuminate from the indicators 318G of beacons indicating clothing products satisfying search criteria of the second user. A third user may be provided a blue indicator 318B on their respective mobile computing device 302 and blue light indicators 318B may illuminate from beacons indicating clothing products satisfying search criteria of the third user.

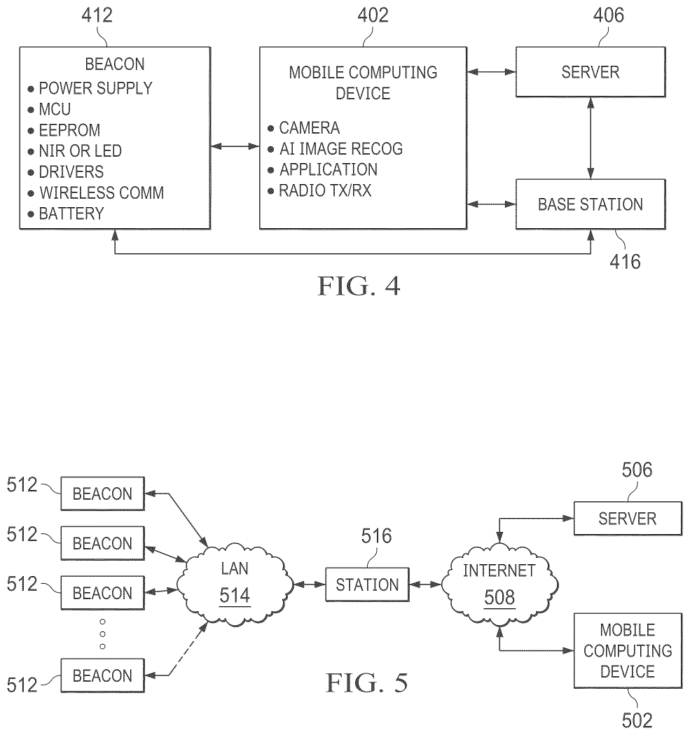

FIG. 4 illustrates a block diagram of an in-store product identification system, the system comprising a beacon 412, a mobile computing device 402, a server 406, and a base station 416. The server 406 may have an application executable on the server 406 to receive a product specification communicated from a user, identify a beacon 412 associated with a product corresponding to the product specification, and generate an instruction to notify the user of a location of the identified beacon 412. Each beacon 412 may have a power supply, a master control unit (MCU), memory (EEPROM), lights such as near infrared light (NIL) or light emitting diode (LED), drivers, wireless communications, and a power supply such as battery. The mobile computing device 402 may have a camera, an artificial intelligence image recognition application, other applications, and radio transmitter/receiver.

A plurality of beacons 412 may be associated with products within a store. A beacon 412 may have a power supply (can also be photovoltaic), an MCU (microcontroller), an EEPROM (electronically erasable programmable read only memory) or RFID (radio-frequency identification), NIR (near infrared) or visible LED(s) (light emitting diodes), driver(s), wireless communication, and a battery. There is no requirement that all of the beacons 412 be the same, and thus some beacons may have some of the elements listed above, while others may have all of the elements listed above. The one on more NIR LEDs may encode digital data transmission to advertise product features. One or more LEDs in the visible spectrum may notify the user or customer about the location of the desired product. The beacon 412 may scan a product via a scanner or camera on the beacon 412 and log the product in an inventory list stored either on the beacon 412, or communicated to a base station 416 and stored on the base station 416, or communicated to a server 406 and stored on the server 406. The beacon 412 may transmit product information to the server 406 through the respective base station 416 and may receive notification instructions from the server. The beacon 412 may work in low power mode to increase battery life, until woken-up to provide communications to a user.

The mobile computing devices 402 may have a shopping assistant application. The shopping assistant application may use the mobile computing device camera (for example, photo mode or video mode at 30+fps) to capture real-time images of products, as well as artificial intelligence AI-based image recognition to identify products. Also, product information may be captured by the mobile computing device 402 via an NIR signal transmitted by the respective beacon 412, utilizing a camera of the mobile computing device 402. The shopping assistant application may produce data (in form of a text), which may be filtered by the user. The shopping assistant application may generate displays to show the location of the products in a map format. The shopping assistant application may log purchased products for product details and specification recall purposes. Mobile computing devices may include, for example, mobile communication devices, smartphones, tablet computers, laptops, such as the Samsung Galaxy Tab®, Google Nexus devices, Amazon Kindle®, Kindle Fire®, Apple iPhone®, the Apple iPad®, Microsoft Surface®, the Palm Pre™, or any device running the Apple IOS, Android® OS, Google Chrome® OS, Symbian OS®, Windows Mobile® OS, Windows Phone, BlackBerry® OS, Embedded Linux, Tizen, Sailfish, webOS, Palm OS® or Palm Web OS®. The shopping assistant application may include application marketplace/store/download service. For example, Google Play, or Apple App Store, without limitation. The shopping assistant application may include any form of software that accepts commands from a server and performs them, e.g., Google Checkin Service, Apple Push Notification Service, without limitation.

The in-store product identification system may comprise a server 406 and a plurality of base stations 416. The base stations 416 may be positioned within stores to communicate with the beacons 412 or the mobile computing devices 402. Product specification information may be communicated from a mobile computing device 402 to a base station 416. Notification information may be communicated from a base station 416 to a mobile computing device 402. In one example, multiple base stations 416 may be installed in the store ceiling at strategic locations for communications with the beacons 412. The base stations 416 may be Internet of things (IOT) stations. The base stations 416 may communicate with the server 406 as well as the beacons 412. The server 406 may communicate with the mobile computing devices 402, in particular the shopping assistant application. The server 406 may have a program for managing user product specification information, product inventory information, and the other components of the overall system.

FIG. 5 illustrates a block diagram of an in-store product identification system, the system comprising a plurality of beacons 512, a base station 516, a mobile computing device 502, and a server 506. The plurality of beacons communicate with the base station 516 via a local area network (LAN) 514, which may be wireless. The base station 516, the server 506, and the mobile computing device 502 communicate with each other via the Internet 508. In another example, the base station and the server communication with each other via a portion of the LAN 514.

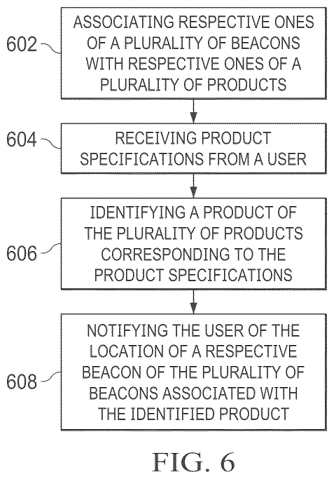

FIG. 6 shows a flow chart of a method for users to identify and locate products. A plurality of products are associated 602 with a plurality of beacons. In one example, respective ones of a plurality of beacons are associated with respective ones of a plurality of products. Product specifications are received 604 from a user, e.g. via an application on a mobile computing device. A product of the plurality of products is identified 606 corresponding to the product specifications, by the server, a base station, or a mobile computing device. The user is notified 608 of the location of a respective beacon of the plurality of beacons associated with the identified product by a beacon or a mobile computing device.

Although examples have been described above, other variations and examples may be made from this disclosure without departing from the spirit and scope of these disclosed examples.

1. A method comprising:
associating respective ones of a plurality of beacons with respective ones of a plurality of products;
receiving a product specification from a user;
identifying a product of the plurality of products corresponding to the product specification; and
notifying the user of a location of a respective beacon of the plurality of beacons associated with the identified product.

2. The method as in claim 1, wherein associating respective ones of a plurality of beacons with respective ones of a plurality of products comprises sensing a product proximate a beacon.

3. The method as in claim 2, wherein sensing the product proximate the beacon comprises reading, via the beacon, an RFID tag of the product.

4. The method as in claim 2, wherein sensing the product proximate the beacon comprises scanning, via the beacon, a readable code of the product.

5. The method as in claim 1, comprising:
providing a server in communication with the plurality of beacons; and
providing to the user an application executable on a processor of a mobile computing device, the application to receive product specifications from the user, and to communicate the product specifications to the server,
wherein receiving product specifications from the user comprises receiving product specifications at the server from the mobile computing device.

6. The method as in claim 1, comprising identifying a respective beacon of the plurality of beacons associated with a product corresponding to the product specification.

7. The method as in claim 1, wherein notifying the user of the location of the respective beacon associated with the identified product comprises activating an alert on a mobile computing device.

8. The method as in claim 1, wherein notifying the user of the location of the respective beacon associated with the identified product comprises illuminating a light associated with the beacon.

9. The method as in claim 1, comprising:
providing to the user an application executable on a processor of a mobile computing device to display a map,
wherein notifying the user of the location of the respective beacon associated with the identified product comprises indicating the location on the map.

10. The method as in claim 1, wherein notifying the user of the location of the respective beacon associated with the identified product comprises providing an indicator on a display of a mobile computing device.

11. A system comprising:
a server;
a base station to communicate with the server;
a plurality of beacons to communicate with the base station, wherein respective ones of the beacons are to be associated with respective ones of products, wherein respective ones of the beacons comprise a power supply, a circuit to control a beacon, a data memory, and a wireless communicator; and
an application executable on a processor of a mobile computing device to receive a product specification from a user and to communicate the product specification to the server; and
an application executable on the server to receive the communicated product specification, identify a respective one of the plurality of beacons associated with the respective product corresponding to the product specification, and generate an instruction to notify the user of a location of the identified beacon.

12. The system of claim 11, wherein respective ones of the beacons comprise a sensor of a product proximate a beacon.

13. The system as in claim 12, wherein the sensor comprises an RFID tag reader.

14. The system as in claim 12, wherein the sensor comprises a code reader.

15. The system as in claim 11, wherein the instruction to notify the user of the location of the identified beacon comprises an instruction to activate an alert on a mobile computing device.

16. The system as in claim 11, wherein the instruction to notify the user of the location of the identified beacon comprises an instruction to illuminate a light associated with the beacon.

17. The system as in claim 11, wherein the application executable on a processor of a mobile computing device is to display a map,
wherein the instruction to notify the user of the location of the identified beacon comprises an instruction to indicate the location of the identified beacon on the map.

18. The system as in claim 11, wherein the instruction to notify the user of the location of the identified beacon is to provide an indicator on a display of a mobile computing device.

19. An application executable on a processor of a mobile computing device, wherein the application is to:
receive an input product specification from a user;
communicate the product specification to a server;
receive beacon location information from a server for a beacon associated with a product corresponding to the product specification; and
inform a user regarding a location of a beacon based on the beacon location information.

20. The application of claim 19, wherein the application is to inform the user regarding a location of the beacon by displaying a map and indicating a location of the beacon on the map.

21. The application of claim 19, wherein the application is to inform the user regarding a location of the beacon by providing an indicator on a display of a mobile computing device.
